(19) United States
(12) Patent Application Publication
(10) Pub. No.: US 2026/0112838 A1
(43) Pub. Date: Apr. 23, 2026

(54) ELECTRONIC DEVICE AND MANUFACTURING METHOD THEREOF

(71) Applicant: LITE-ON TECHNOLOGY CORPORATION, Taipei (TW)

(72) Inventors: Bo-Liang LIN, Taipei (TW); Yu-Hsin LIN, Taipei (TW); Yi-Jen Lu, Taipei (TW); Ying-Hsien CHEN, Taipei (TW)

(21) Appl. No.: 19/211,340

(22) Filed: May 19, 2025

(30) Foreign Application Priority Data
Oct. 22, 2024 (CN) 202422551134.4

(51) Int. Cl. H01R 13/502; H01R 13/22; H01R 13/66; H01R 43/20; H01R 103/00

(52) U.S. Cl. CPC H01R 13/502; H01R 13/22; H01R 13/6658; H01R 43/20; H01R 2103/00; H01R 2201/06

(57) ABSTRACT

An electronic device includes an electronic component, a first shell and a second shell. The first shell is located between the electronic component and the second shell, and the first shell and the electronic component are located in the second shell.

This application claims the benefit of China application Serial No. 202422551134.4, filed Oct. 22, 2024, the disclosure of which is incorporated by reference herein in its entirety.

### TECHNICAL FIELD

The disclosure relates in general to an electronic device and a manufacturing method thereof.

### BACKGROUND

With the increasing popularity of consumer electronic devices and the current demand for environmentally friendly, energy-saving and high-efficiency equipment, the market has been directed towards the use of a small and fast charger (PD Chargers) with high power density. It increases the technical difficulty in the research and development process. Due to the local high temperature brought to the charger by the high power density, it is undoubtedly a challenge in heat dissipation technology.

### SUMMARY

The present disclosure provides an electronic system and an electronic device thereof capable of resolving the conventional problem.

According to an embodiment, an electronic device is provided. The electronic device includes an electronic component, a first shell and a second shell. The first shell is located between the electronic component and the second shell, and the first shell and the electronic component are located within the second shell.

In an embodiment, the first shell and the second shell are at least partially spaced apart.

In an embodiment, the first shell and the second shell are at least partially in contact.

In an embodiment, the first shell includes a first coupling portion, and the first coupling portion is in contact with a portion of a surface of the second shell.

In an embodiment, the first shell includes a first shell and a first coupling portion, the first coupling portion is not coplanar with a surface of the first shell, the second shell includes a second shell and a second coupling portion, the second coupling portion is not coplanar with a surface of the second shell, and the first coupling portion and the second coupling portion are disposed correspondingly.

In an embodiment, the electronic device further includes a heat conductive layer disposed between the first shell and the second shell.

In an embodiment, the first shell has an outer surface and an isolation portion, the isolation portion is recessed relative to the outer surface, an interval between the first shell and the second shell is corresponding to the isolation portion, a gap between the first shell and the second shell is corresponding to a region outside the isolation portion, and the interval is greater than the gap.

In an embodiment, the electronic device further includes a packaging material disposed within the first shell and covering at least a portion of the electronic component. The packaging material is in contact with a portion of the inner surface of the first shell.

In an embodiment, the electronic device further includes a connection module electrically connected to the electronic component and combined with the second shell. The first shell has a first opening toward the connection module, the second shell has a second opening, and the connection module is disposed in the second opening.

In an embodiment, the first shell has an end surface, and there is a gap between the end surface and the connection module.

According to another embodiment, a manufacturing method for an electronic device is provided. The manufacturing method includes the following steps: electrically connecting the electronic component and a connection module, wherein the electronic component and the connection module form a first pre-assembled component; disposing the first pre-assembled component within a first shell, wherein the first pre-assembled component and the first shell form a second pre-assembled component; disposing the second pre-assembled component within a second shell, wherein the first shell is located between the electronic component and the second shell; and combining the connection module with the second shell.

In an embodiment, the manufacturing method further includes: forming a packaging material within the first shell, wherein the packaging material covers at least a portion of the electronic component.

In an embodiment, the electronic component includes a connector exposed from the first shell; before forming the packaging material within the first shell, the manufacturing method further includes: disposing a plug in an opening of the connector.

In an embodiment, step of combining the connection module with the second shell includes: combining the connection module with the second shell by an ultrasonic technology.

According to another embodiment, an electronic device is provided. The electronic device includes an electronic assembly, a first shell, a second shell, a packaging material and a connection module. The first shell and the electronic assembly are disposed within the second shell. The packaging material is disposed within the first shell and covers at least a portion of the electronic assembly. The connection module is connected to the second shell, wherein the first shell has an end surface facing the connection module.

In an embodiment, the connection module abuts against the second shell at an abutment portion, and there is a gap between the end surface and the abutment portion.

In an embodiment, the packaging material contacts a portion of an inner surface of the first shell, and a top surface of the packaging material does not exceed the end surface of the first shell.

In an embodiment, a portion of the outer surface of the first shell has a heat conductive material.

In an embodiment, the first shell has a through hole, and the through hole and the end surface are disposed on different sides of the first shell.

In an embodiment, the first shell includes a first portion, a second portion and a first opening facing the connection module, and at least a portion of the first portion is not connected to the second portion.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an electronic device according to an embodiment of the present invention;

FIG. 2 shows a schematic diagram of an exploded view of the electronic device of FIG. 1;

FIG. 3 shows a schematic diagram of an exploded view of an electronic module of FIG. 1;

FIG. 4A shows a schematic diagram of a cross-sectional view of the electronic device in FIG. 1 along a direction 4A-4A′;

FIG. 4B shows a schematic diagram of a cross-sectional view of the electronic device in FIG. 1 along a direction 4B-4B′;

FIG. 4C shows a schematic diagram of a cross-sectional view of the electronic device in FIG. 1 along a direction 4C-4C′;

FIG. 4D shows a schematic diagram of a cross-sectional view of the electronic device in FIG. 1 along a direction 4D-4D′;

FIG. 5 shows a schematic diagram of an electronic device according to another embodiment of the present invention;

FIG. 6 shows a schematic diagram of an exploded view of the electronic device in FIG. 5;

FIG. 7 shows a schematic diagram of another exploded view of the electronic device in FIG. 5;

FIG. 8A shows a schematic diagram of a cross-sectional view of the electronic device in FIG. 5 along a direction 8A-8A′;

FIG. 8B shows a schematic diagram of the electronic device in FIG. 5 along a direction 8B-8B′;

FIG. 8C shows a schematic diagram of a cross-sectional view of the electronic device in FIG. 5 along a direction 8C-8C′;

FIG. 8D shows a schematic diagram of the electronic device in FIG. 5 along a direction 8D-8D′; and

FIGS. 9A to 9F illustrate schematic diagrams of the manufacturing processes of the electronic device in FIG. 1.

### DETAILED DESCRIPTION

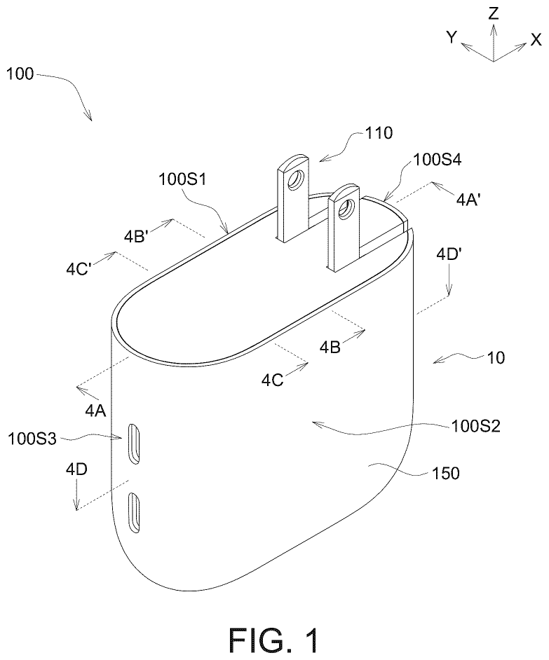

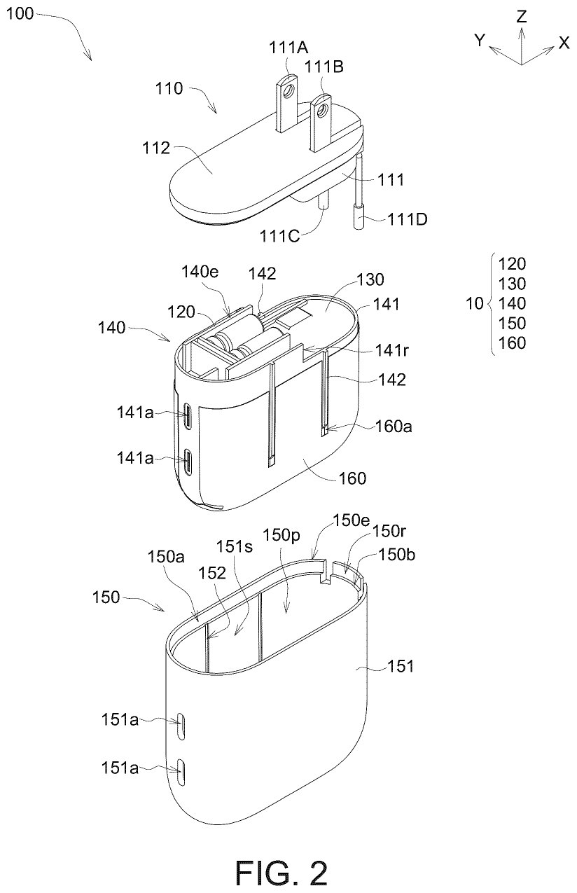

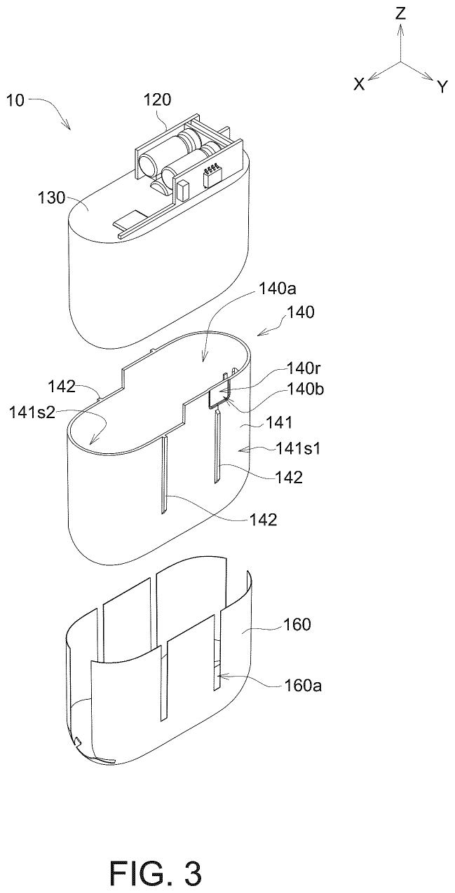

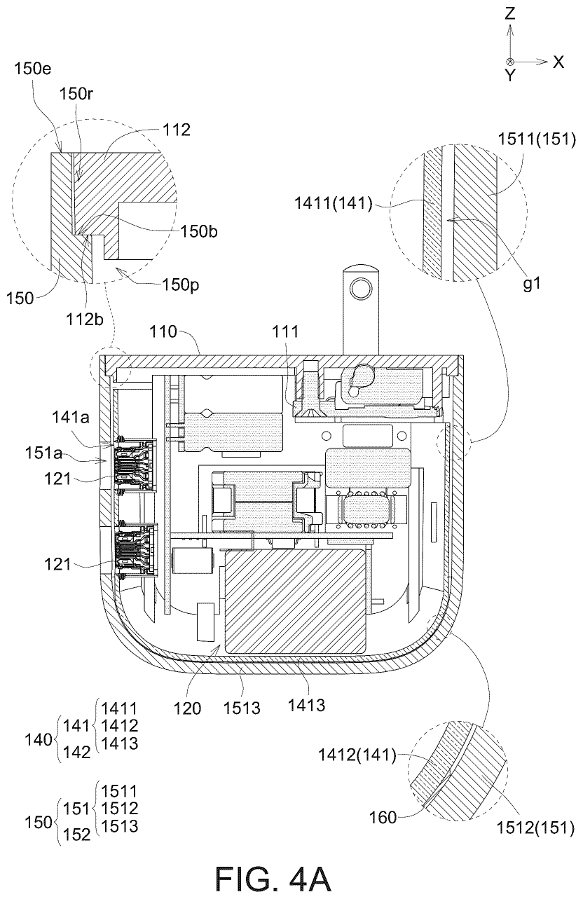

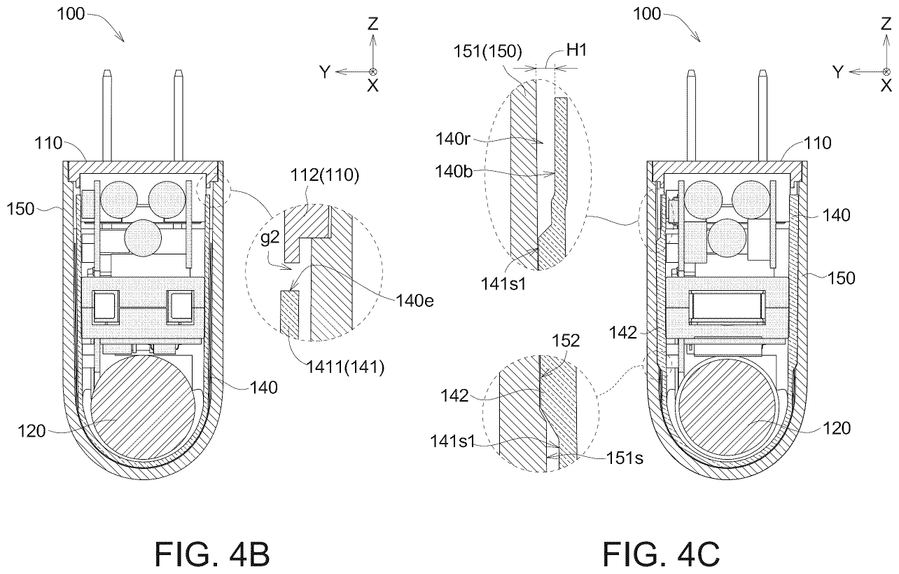

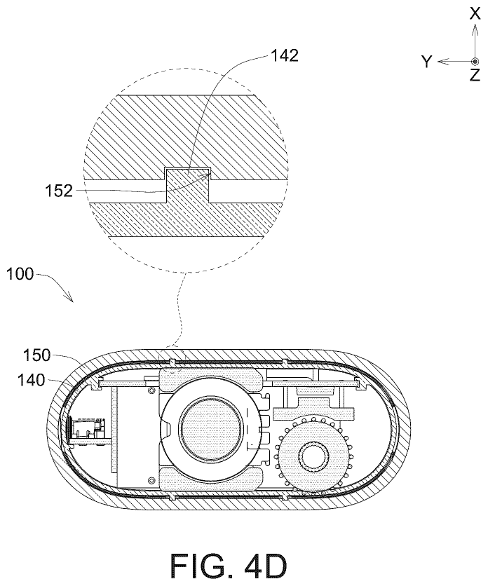

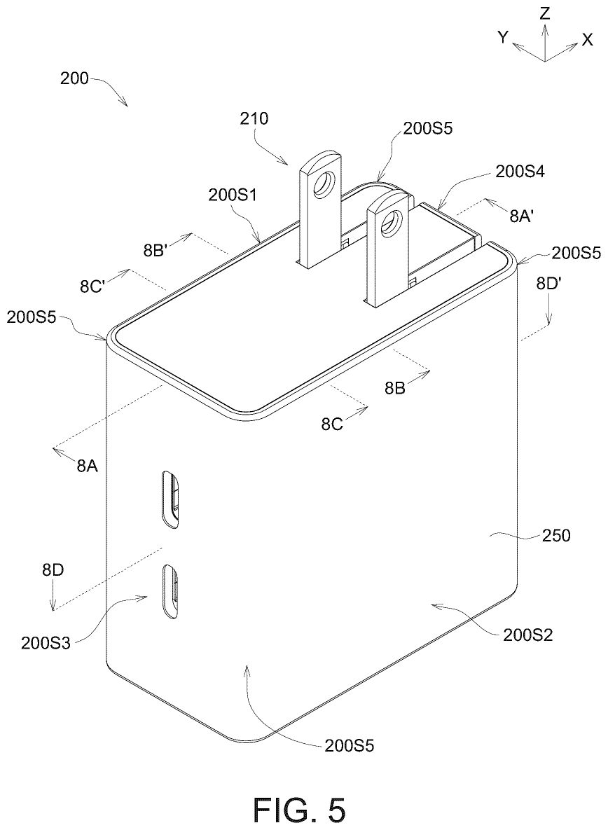

Referring to FIGS. 1 to 4D, FIG. 1 shows a schematic diagram of an electronic device 100 according to an embodiment of the present invention, FIG. 2 shows a schematic diagram of an exploded view of the electronic device 100 of FIG. 1, FIG. 3 shows a schematic diagram of an exploded view of an electronic module 10 of FIG. 1, FIG. 4A shows a schematic diagram of a cross-sectional view of the electronic device 100 in FIG. 1 along a direction 4A-4A′, FIG. 4B shows a schematic diagram of a cross-sectional view of the electronic device 100 in FIG. 1 along a direction 4B-4B′, FIG. 4C shows a schematic diagram of a cross-sectional view of the electronic device 100 in FIG. 1 along a direction 4C-4C′, and FIG. 4D shows a schematic diagram of a cross-sectional view of the electronic device 100 in FIG. 1 along a direction 4D-4D′. To avoid overly complicating the illustration, a packaging material 130 is not shown in FIGS. 4A to 4D.

As shown in FIG. 1, in the present embodiment, the electronic device 100 has a first surface 100S1 and a second surface 100S2 opposite to the first surface 100S1 and a third surface 100S3 and a fourth surface 100S4 opposite to the third surface 100S3, wherein the first surface 100S1 and the second surface 100S2 are connected to the third surface 100S3 and the fourth surface 100S4. In the present embodiment, the first surface 100S1 and the second surface 100S2 are, for example, planes, and the third surface 100S3 and the fourth surface 100S4 are, for example, curved surfaces, such as elliptica surfaces, arcuate surfaces, etc.

As shown in FIGS. 1 to 3, the electronic device 100 includes a connection module 110 and an electronic module 10. In the present embodiment, the electronic device 100 takes a charger (for example, a small and fast charger with high power density) as an example, wherein the connection module 110 is a plug module that may be inserted into a socket (it is electrically connected with a power supply), such power supply (not shown) may be transmitted to the electronic module 10 through the connection module 110, and then transmitted to an external electronic device (not shown) connected to the electronic device 100, wherein the external electronic device are, for example, computers, smartphones, home appliances, etc.

As shown in FIGS. 1 to 3, the electronic module 10 includes an electronic component 120, a packaging material 130, a first shell 140, a second shell 150 and a heat conductive layer (or heat conductive material) 160. The first shell 140 is located between the electronic component 120 and the second shell 150, and the first shell 140 and the electronic component 120 are located within the second shell 150. As a result, the first shell 140 may increase a thermal resistance of the heat conduction from the electronic component 120 to the second shell 150 and accordingly it may prevent the temperature of the second shell 150 from being too high. In other words, the first shell 140 may serve as a thermal resistance between the electronic component 120 and the second shell 150, and this it may hinder the heat conduction of the electronic component 120 and prevent the temperature of the second shell 150 from being too high. Due to the thermal resistance design of the electronic module 10, when the electronic device 100 is operating, the temperature difference between the maximum temperature of the second shell 150 and an ambient temperature is not greater than a legal limit value. Depending on the regulations, the legal limit value is, for example, 52 degrees, but may be higher or lower. In addition, due to the thermal resistance design of the electronic module 10, the electronic device 100 is suitable for the energy transmission with high power density. For example, if the power density of the electronic device 100 is equal to or greater than 0.8 Watts/cubic centimeter (W/cc), it may still comply with the aforementioned temperature regulations. In other words, even if the electronic device 100 is designed as a high-power output device or a small-volume device, it may still meet the temperature requirements of regulations.

As shown in Table 1 below, it presents the temperature performance of the electronic device of the comparative example and the electronic device 100 of the present embodiment after heat flow simulation (for example, using Flotherm XT software). The difference between the electronic device of the comparative example and the electronic device 100 of this embodiment of the present invention is that the shell component of the electronic device of the comparative example is a single-layer shell. The unit of temperature in Table 1 is, for example, degrees Celsius. The maximum measured temperature in Table 1 is, for example, the maximum temperature value of the temperature distribution on the surface, and the temperature difference is, for example, the temperature difference between the maximum measured temperature and the ambient temperature (for example, 35 degrees Celsius). Taking the legal limit value as 42 degrees Celsius as an example, compared with the electronic device in the comparative example where three surfaces failed verification, all six surfaces of the electronic device 100 in the embodiment of the present invention (six outer surfaces of the electronic device 100 in FIG. 1) have all passed the verification, and it may prove that the thermal resistance design of the electronic device 100 according to the embodiment of the present invention may effectively reduce the temperature of the shell (for example, the second shell 150) of the electronic device 100.

TABLE 1

| | Maximum measured | Temperature | Verification |
|---|---|---|---|
| | temperature | difference | result |
| | Electronic device of comparative example | | |
| bottom surface | 74.2 | 39.2 | PASS |
| top surface | 73.1 | 38.1 | NOT PASS |
| first surface | 80.8 | 45.8 | NOT PASS |
| 110S1 | | | |
| second surface | 81.6 | 46.6 | NOT PASS |
| 110S2 | | | |
| third surface | 74.1 | 39.1 | PASS |
| 110S3 | | | |
| fourth surface | 78.5 | 43.5 | NOT PASS |
| 110S4 | | | |
| | Electronic device 100 | | |
| bottom surface | 73.5 | 38.5 | PASS |
| top surface | 74.0 | 39.0 | PASS |
| first surface | 74.1 | 39.1 | PASS |
| 110S1 | | | |
| second surface | 75.4 | 40.4 | PASS |
| 110S2 | | | |
| third surface | 73.3 | 38.3 | PASS |
| 110S3 | | | |
| fourth surface | 72.9 | 37.9 | PASS |
| 110S4 | | | |

As shown in FIG. 2, the connection module 110 includes a connector 111 and a cover 112, wherein the connector 111 is fixed to the cover 112. The connector 111 includes a first electrode 111A, a second electrode 111B, a first connection line 111C and a second connection line 111D. The first electrode 111A and the second electrode 111B are disposed through the cover 112 and may rotate relative to the cover 112. The first connection line 111C and the second connection line 111D are electrically connected to the first electrode 111A and the second electrode 111B respectively. The first connection line 111C and the second connection line 111D may be electrically connected to the electronic component 120, so that the power transmitted to the first electrode 111A and the second electrode 111B may be transmitted to the electronic components 120 through the first connection line 111C and the second connection line 111D.

As shown in FIGS. 2 and 4A, the electronic component 120 is, for example, a circuit board assembly (PCBA), but the invention is not limited thereto. In addition, the electronic component 120 may also be called a movement (or machine core). The electronic component 120 includes at least one connector 121, which may be exposed from the first shell 140 and the second shell 150, so that a connector of an external electronic device may be connected to the connector 121. The connector 121 is, for example, a connector that complies with the Universal Serial Bus (USB) specification, such as USB-C, but the embodiment of the present invention is not limited thereto. When the electronic device 100 is a charger, the electronic component 120 may include a voltage conversion circuit (for example, buck or boost) to convert the voltage of the power supply into a voltage suitable for operation of the external electronic device.

As shown in FIGS. 2 to 3, the packaging material 130 is disposed in the first shell 140 and encapsulate or covers at least a portion of the electronic component 120. The packaging material 130 may conduct heat generated by the electronic component 120. Furthermore, the packaging material 130 has a certain volume which may provide sufficient thermal capacity absorbs the heat of the electronic component 120, and it may prevent the temperature of the electronic component 120 from being too high and prevent the temperature of the second shell 150 from being too high. In addition, the packaging material 130 may contact at least a portion of a surface 141s2 (for example, an inner surface) of the first shell 140 to more evenly distribute the heat in the first shell 140, and it may prevent the heat from being concentrated at a specific location. In addition, the packaging material 130 is, for example, filling glue, and its material may include epoxy resin, polyurethane (PU) or silicone. In other embodiments, the electronic device 100 may also omit the packaging material 130.

As shown in FIGS. 2 to 3, the first shell 140 has a first opening 140a facing the connection module 110. A portion of the connection module 110 in FIG. 2 may enter the first shell 140 through the first opening 140a. The first shell 140 is disposed within the second shell 150, so the first shell 140 may be called an inner shell. The second shell 150 is, for example, the outermost layer of the electronic device 100, so the second shell 150 may be called an outer shell. In the present embodiment, the first shell 140 and the second shell 150 form a multi-layered shell. In another embodiment, the aforementioned multi-layered shell may include more than N layers of shell, wherein N is, for example, a positive integer equal to or greater than 3.

As shown in FIGS. 3, 4A and 4C, the first shell 140 includes a first shell body 141 and at least one first coupling portion 142, wherein the first coupling portion 142 is connected to the first shell body 141. The first coupling portion 142 is not coplanar with a surface of the first shell body 141. For example, the first shell body 141 has the surface 141s1 (for example, an outer surface), and the first coupling portion 142 protrudes relative to the surface 141s1 (the first coupling portion 142 is like a rib). The surface 141s1 is, for example, the outer surface of the first shell body 141. In an embodiment, the first shell body 141 and the first coupling portion 142 may form an integrally formed structure.

As shown in FIGS. 2 and 4A, the first shell body 141 of the first shell 140 has at least one first through hole 141a, and the first through hole 141a and the end surface 140e are disposed on different sides of the first shell 140. The connector 121 of the electronic component 120 may be exposed from the first through hole 141a, so that the connector of the external electronic device may be connected to the connector 121 through the first through hole 141a.

As shown in FIGS. 3 and 4C, the first shell 140 further has at least one isolation portion 140r. The isolation portion 140r is recessed relative to the surface 141s1 to form an interval H1 between a second shell body 151 and the first shell 140 (the interval between the second shell body 151 and a bottom surface 140b of the isolation portion 140r). In an embodiment, there is a gap between the first shell 140 and the second shell 150 corresponding to the area outside the isolation portion 140r, and the interval H1 may be larger than the aforementioned gap. The interval H1 may increase the thermal resistance between the first shell 140 and the second shell 150, and it may locally strengthen the isolation effect for the high-power electronic component and prevent the temperature of the second shell 150 from being too high. In an embodiment, the isolation portion 140r may be located corresponding a high temperature point of the second shell 150 (for example, a place with a higher temperature or the highest temperature compared to the overall temperature (or an average temperature) of the electronic device 100) to slow down the heat conduction of the high temperature point to a corresponding surface of the second shell 150.

As shown in FIG. 4B, the first shell 140 has an end surface 140e, and there is a gap between the end surface 140e and the connection module 110, that is, they are spaced apart from each other. In the present embodiment, there is a gap g2 between the end surface 140e and the cover 112 of the connection module 110, wherein the gap g2 may increase the thermal resistance between the first shell 140 and the connection module 110 to prevent the temperature of the connection module 110 from being too high. In addition, the gap g2 may absorb an assembly tolerance and avoid an interference between the first shell 140 and the connection module 110 due to the assembly tolerance.

As shown in FIG. 2, the first shell body 141 of the first shell 140 has a notch 141r, and the notch 141r is recessed relative to the end surface 140e of the first shell 140. When the first shell 140 is assembled with the connection module 110, the notch 141r may accommodate the connector 111 of the connection module 110 to prevent the physical material of the first shell body 141 from interfering with the connector 111.

As shown in FIGS. 2 and 4A, the second shell 150 has a second opening 150a, and the connection module 110 may be disposed in the second opening 150a. For example, the cover 112 of the connection module 110 may be disposed in the second opening 150a. The second shell 150 has an accommodating groove 150p, an end surface 150e and a groove 150r, wherein the groove 150r extends from the end surface 150e toward the bottom of the accommodating groove 150p to form a groove bottom surface 150b. The aforementioned second opening 150a is, for example, an opening in which the accommodation groove 150p is exposed from the end surface 150e. The second shell 150 is connected to the connection module 110. For example, the cover 112 of the connection module 110 abuts against the second shell 150 at an abutment portion. For example, the second shell 150 and the cover 112 may be fixed to each other by using, for example, an ultrasonic welding process. The cover 112 has a bottom surface 112b, and the bottom surface 112b of the cover 112 is in contact with the groove bottom surface 150b of the second shell 150 (for example, in the abutment portion) by using, for example, an ultrasonic welding process. Through the ultrasonic welding process, the contact portions of the cover 112 and the second shell 150 are melted and fixed to each other.

As shown in FIGS. 2 and 4C, the second shell 150 includes the second shell body 151 and at least one second coupling portion 152, wherein the second coupling portion 152 is disposed on the second shell body 151. The second shell body 151 has the aforementioned first surface 100S1, second surface 100S2, third surface 100S3 and fourth surface 100S4. The second coupling portion 152 is not coplanar with a surface of the second shell body 151, and the first coupling portion 142 and the second coupling portion 152 are disposed oppositely. For example, the second shell body 151 has a surface 151s, and the second coupling portion 152 is recessed (i.e., not coplanar) relative to the surface 151s. The surface 151s is, for example, the inner wall surface of the aforementioned accommodation groove 150p. In an embodiment, the second shell body 151 and the second coupling portion 152 may form an integrally formed structure. In other embodiment, the second shell 150 may omit the aforementioned second coupling portion 152, so that the first coupling portion 142 of the first shell 140 may abut against or contact a portion of the surface of the second shell 150, for example, the surface 151s.

As shown in FIGS. 4C and 4D, the second coupling portion 152 of the second shell 150 and the first shell body 141 of the first coupling portion 142 of may be combined with each other to fix a relative position between the first shell 140 and the second shell 150. The second coupling portion 152 of the second shell 150 and the first coupling portion 142 of the first shell body 141 match in shape, so that the first coupling portion 142 and the second coupling portion 152 are easily combined with each other. The first coupling portion 142 and the second coupling portion 152 may provide positioning and guiding functions. As a result, during the manufacturing process of the electronic device 100, through an alignment of the second coupling portion 152 and the first coupling portion 142, the first shell 140 and the second shell 150 may be quickly coupled. In an embodiment, a fit between the second coupling portion 152 and the first coupling portion 142 is, for example, a loose fit or a transition fit. Compared with an interference fit, the loose fit or the transition fit may effortlessly combine the first shell 140 and the second shell 150.

As shown in FIGS. 2 and 4A, the second shell body 151 of the second shell 150 has at least one second through hole 151a, and the connector 121 of the electronic component 120 may be exposed from the second through hole 151a, so that the connector of the external electronic device may be connected to the connector 121 through the second through hole 151a.

As shown in FIG. 4A, the second shell 150 and the first shell 140 may be at least partially spaced apart. For example, the first shell body 141 includes a first portion 1411 (for example, an upper portion) and a second portion 1412 (for example, a lower portion) connected to the first portion 1411, and the second shell body 151 includes a third portion 1511 (for example, an upper portion) and a fourth portion 1512 (for example, a lower portion) connected to the third portion 1511. In the present embodiment, the first portion 1411 of the first shell 140 and the third portion 1511 of the second shell 150 are spaced apart from each other by a gap g1, wherein the gap g1 may increase the thermal resistance between the first shell 140 and the second shell 150, and accordingly it may prevent the temperature of the second shell 150 from being too high. In another embodiment, the first portion 1411 of the first shell 140 and the third portion 1511 of the second shell 150 may also be in contact with each other.

As shown in FIG. 4A, the second portion 1412 of the first shell 140 and the fourth portion 1512 of the second shell 150 may be spaced apart from each other. For example, the second portion 1412 of the first shell 140 and the fourth portion 1512 of the second shell 150 may be spaced apart from each other through the heat conductive layer 160. In another embodiment, if the heat conductive layer 160 is omitted, the second portion 1412 of the first shell 140 and the fourth portion 1512 of the second shell 150 may be in direct contact. In an embodiment, at least a portion of the first portion 1411 may not be connected to the second portion 1412, in other words, the first shell 140 does not necessarily have to be an intact continuous shell having multi-surface.

As shown in FIG. 4A, the first shell body 141 further includes a first bottom portion 1413 which connects the first portion 1411 with the second portion 1412, and the second shell body 151 further includes a second bottom portion 1513 which connects the third portion 1511 with the fourth portion 1512. The first bottom portion 1413 and the second bottom portion 1513 may be separated by the heat conductive layer 160. If the heat conductive layer 160 is omitted, the first bottom portion 1413 and the second bottom portion 1513 may be in direct contact. In other embodiment, the first bottom portion 1413 and the second bottom portion 1513 may be spaced apart from each other to increase the thermal resistance between the first shell 140 and the second shell 150 to prevent the temperature of the second shell 150 from being too high.

In summary, the first shell body 141 of the first shell 140 and the second shell body 151 of the second shell 150 may be at least partially in contact with each other and/or at least partially spaced apart from each other. The aforementioned gap is, for example, filled with an air layer, wherein the air layer has a thermal insulation effect and forms the thermal resistance. In addition, the first shell 140 and/or the second shell 150 are formed of, for example, an electrical insulating material or a fireproof material, such as plastic, rubber, etc., wherein the plastic material includes, for example, polycarbonate (PC), polypropylene (PP), acrylonitrile butadiene styrene (ABS) or nylon (Nylon), etc. However, in another embodiment, the first shell 140 and/or the second shell 150 are formed of materials with better thermal conductivity, such as metal, ceramic material, graphite, etc. In addition, the first shell 140 and the second shell 150 may be formed of the same or different materials. For example, the first shell 140 and the second shell 150 are formed of plastic which may provide insulation and fire prevention effects. For another example, the first shell 140 is formed of, for example, metal, and the second shell 150 is formed of, for example, plastic. The first shell 140 may conduct heat uniformly, so that the temperature difference between the highest temperature and the lowest temperature of the second shell 150 may be reduced.

As shown in FIGS. 2 and 3, the heat conductive layer 160 may be disposed on the first shell 140. When the first shell 140, the second shell 150 and the heat conductive layer 160 are assembled, the heat conductive layer 160 is located between the first shell 140 and the second shell 150. In an embodiment, the heat conductive layer 160 covers at least 50% of the surface of the first shell 140. The heat conductive layer 160 may provide a uniform heat conduction function, so that the heat is more evenly distributed in the first shell 140, and it accordingly prevents the heat from being concentrated in a specific position. Furthermore, the heat conductive layer 160 may prevent heat from being concentrated at a certain position of the first shell 140, thereby preventing the temperature of the corresponding position (corresponding to such certain position) of the second shell 150 from being too high. In terms of material, the heat conductive layer 160 may be formed of metal, such as aluminum, copper, gold, iron or a combination thereof. In an embodiment, the heat conductive layer 160 may be aluminum foil. In terms of manufacturing process, the heat conductive layer 160 may be formed on the first shell 140 by, for example, laminating, adhesion, coating, electroplating, electroless plating, deposition, etc. The heat conductive layer 160 has, for example, at least one hollow portion 160a. The hollow portion 160a is disposed corresponding to the first bonding portion 142 to avoid interference or overlap between the physical portion of the heat conductive layer 160 and the first bonding portion 142. In other embodiment, the electronic device 100 may omit the heat conductive layer 160.

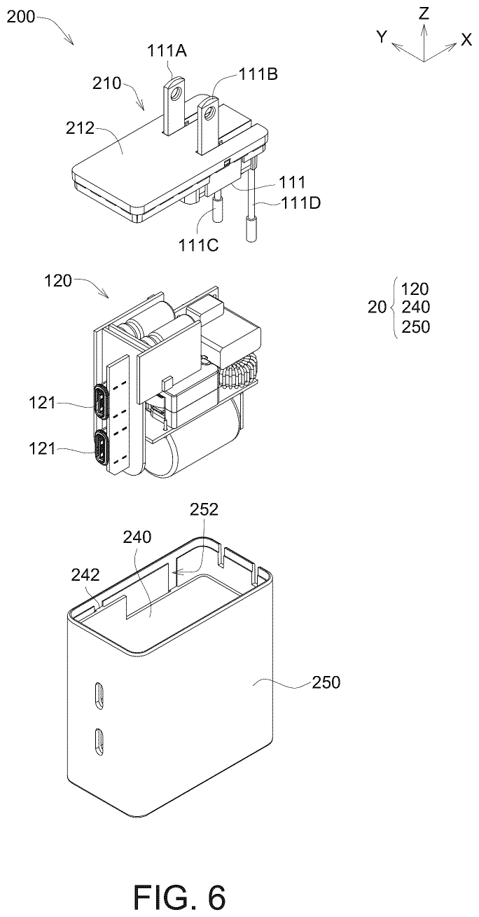

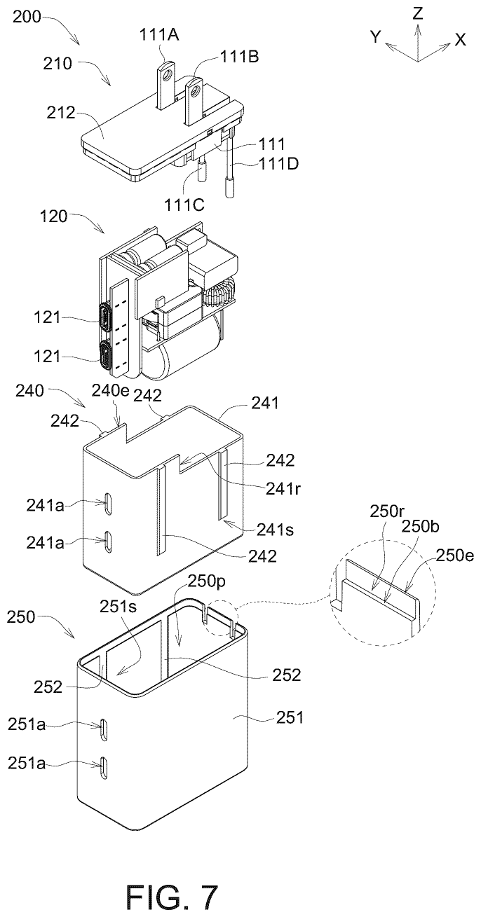

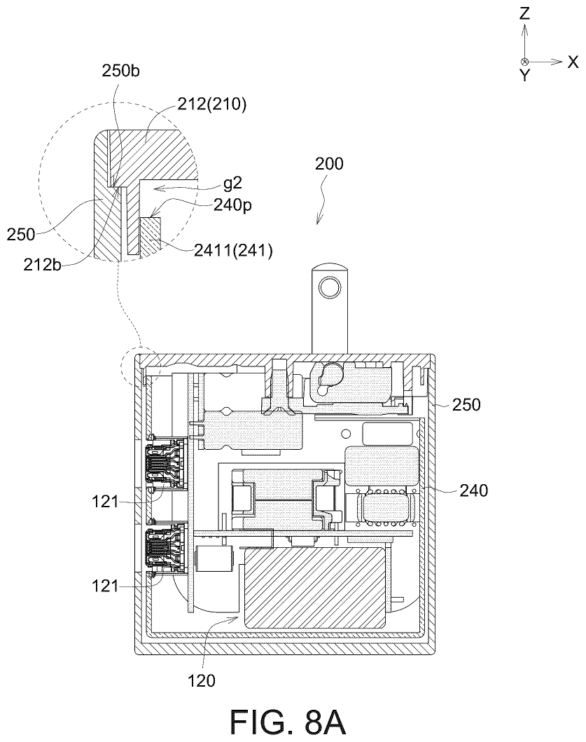

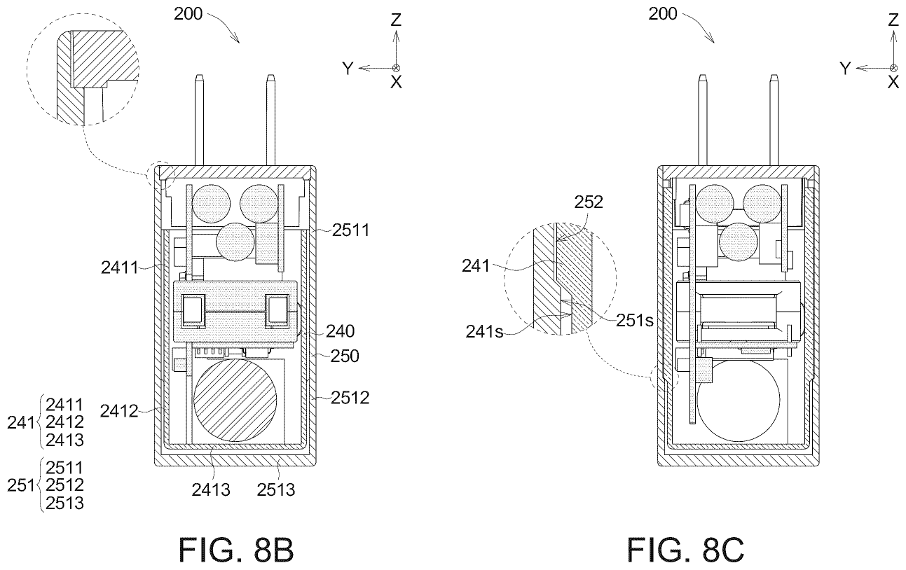

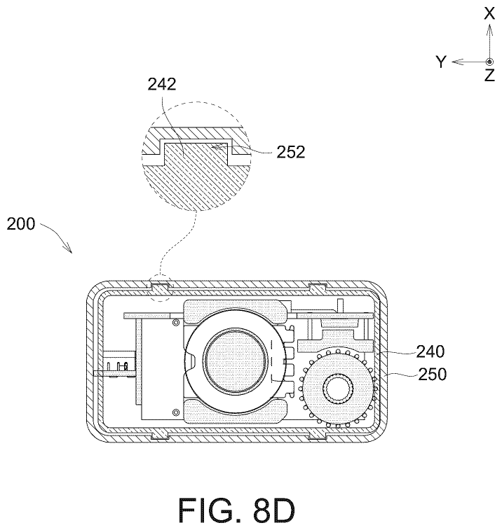

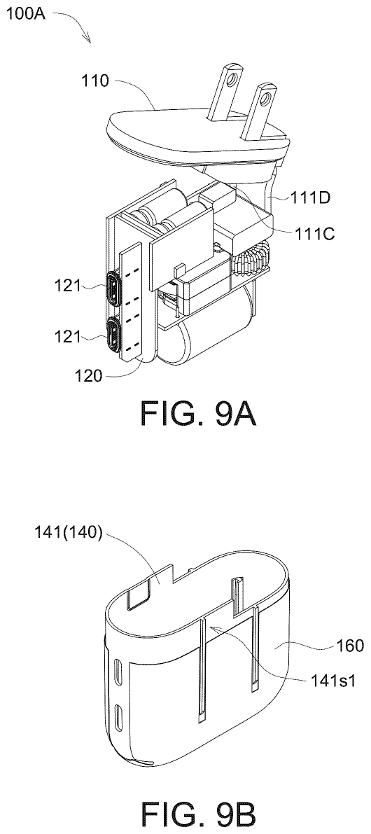

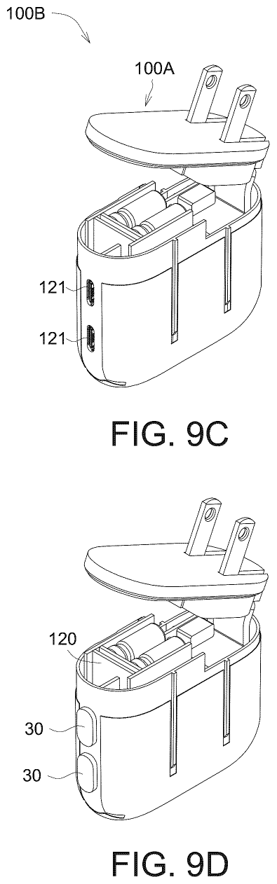

Referring to FIGS. 5 to 8D, FIG. 5 shows a schematic diagram of an electronic device 200 according to another embodiment of the present invention, FIG. 6 shows a schematic diagram of an exploded view of the electronic device 200 in FIG. 5, FIG. 7 shows a schematic diagram of another exploded view of the electronic device 200 in FIG. 5, FIG. 8A shows a schematic diagram of a cross-sectional view of the electronic device 200 in FIG. 5 along a direction 8A-8A′, FIG. 8B shows a schematic diagram of the electronic device 200 in FIG. 5 along a direction 8B-8B′, FIG. 8C shows a schematic diagram of a cross-sectional view of the electronic device 200 in FIG. 5 along a direction 8C-8C′, and FIG. 8D shows a schematic diagram of the electronic device 200 in FIG. 5 along a direction 8D-8D′. To simplify the illustration, the packaging material 130 is not shown in FIGS. 5 to 8D.

As shown in FIGS. 5 to 7, the electronic device 200 includes a connection module 210 and an electronic module 20. In the present embodiment, the electronic device 200 takes a charger as an example, wherein the connection module 210 is a plug module that may be inserted into a socket (which is electrically connected to a power supply), and such power supply (not shown) may be transmitted to the electronic module 20 through the connection module 210, and then transmitted to an external electronic device (not shown) connected with the electronic device 200, wherein the external electronic device is, for example, a computer, a smart phone, a home appliance, etc.

As shown in FIGS. 5 to 7, the electronic module 20 includes an electronic component 220, a packaging material 130 (not shown), a first shell 240, a second shell 250 and the heat conductive layer 160 (not shown). The first shell 240 is disposed between the electronic component 220 and the second shell 250, and the first shell 240 and the electronic component 220 are disposed within the second shell 250. As a result, the first shell 240 may block the heat of the electronic component 220 from being transmitted to the second shell 250 and prevent the temperature of the second shell 250 from being too high. In other words, the first shell 240 may be used as a thermal resistance between the electronic component 220 and the second shell 250 to prevent the temperature of the second shell 250 from being too high. Due to the thermal resistance design of the electronic module 20, when the electronic device 200 is operating, the temperature difference between the maximum temperature of the second shell 250 and the ambient temperature is not greater than the legal limit value. Depending on the regulations, the legal limit value is, for example, 52 degrees, but may be higher or lower.

The electronic device 200 includes the technical features same as or similar to that of the electronic device 100, and at least one difference is that the electronic device 200 is different from the electronic device 100 in appearance. For example, the electronic device 200 has a first surface 200S1 and a second surface 200S2 opposite to the first surface 200S1, a third surface 200S3 and a fourth surface 200S4 opposite to the third surface 200S3 and at least one connection surface 200S5, wherein two of the first surface 200S1, the second surface 200S2, the third surface 200S3 and the fourth surface 200S4 may be connected by the connection surface 200S5 or directly connected to each other. A difference from the appearance of the aforementioned electronic device 100 is that the third surface 200S3 and the fourth surface 200S4 of the electronic device 200 of the present embodiment are, for example, flat surfaces, and the connection surface 200S5 is, for example, a curved surface, such as an elliptical surface, an arc surface, etc.

As shown in FIG. 6, the connection module 110 includes the connector 111 and a cover 212, wherein the connector 111 is fixed to the cover 212. The connector 111 includes the first electrode 111A, the second electrode 111B, the first connection line 111C and the second connection line 111D. The first electrode 111A and the second electrode 111B are disposed through the cover 212 and may rotate relative to the cover 212. The first connection line 111C and the second connection line 111D are electrically connected to the first electrode 111A and the second electrode 111B respectively. The first connection line 111C and the second connection line 111D may be electrically connected to the electronic component 120, so that the power transmitted to the first electrode 111A and the second electrode 111B may be transmitted to the electronic components 120 through the first connection line 111C and the second connection line 111D.

As shown in FIGS. 6 and 8A, the electronic component 120 is, for example, a circuit board assembly (PCBA), but the invention is not limited thereto. In addition, the electronic component 120 may also be called a movement (or machine core). The electronic component 120 includes at least one connector 121, which may be exposed from the first shell 240 and the second shell 250, so that a connector of an external electronic device may be connected to the connector 121. The connector 121 is, for example, a connector that complies with the Universal Serial Bus (USB) specification, such as USB-C, but the embodiment of the present invention is not limited thereto. When the electronic device 200 is a charger, the electronic component 220 may include a voltage conversion circuit (for example, buck or boost) to convert the voltage of the power supply into a voltage suitable for operation of the external electronic device.

Although not shown, in another embodiment, the packaging material 130 (shown in FIG. 2) may be disposed in the first shell 240 and cover at least a portion of the electronic component 120. The packaging material 130 may conduct heat generated by the electronic component 120. Furthermore, the packaging material 130 has a certain volume which may provide sufficient thermal capacity absorbs the heat of the electronic component 120, and it may prevent the temperature of the electronic component 120 from being too high and prevent the temperature of the second shell 250 from being too high. In other embodiment, the electronic device 200 may also omit the packaging material 130.

As shown in FIGS. 6 to 7, the first shell 240 is disposed within the second shell 250, so the first shell 240 may be called an inner shell. The second shell 250 is, for example, the outermost layer of the electronic device 200, so the second shell 250 may be called an outer shell. In the present embodiment, the first shell 240 and the second shell 250 form a multi-layered shell. In another embodiment, the aforementioned multi-layer shell may include more than N layers of shell, wherein N is, for example, a positive integer equal to or greater than 3.

As shown in FIGS. 7 and 8B, the first shell 240 includes a first shell body 241 and at least one first coupling portion 242, wherein the first coupling portion 242 is connected to the first shell body 241. For example, the first shell body 241 has a surface 241s, and the first coupling portion 242 protrudes relative to the surface 241s (the first coupling portion 242 is like a rib). The surface 241s is, for example, an outer surface of the first shell body 241. In an embodiment, the first shell body 241 and the first coupling portion 242 form, for example, an integrally formed structure.

As shown in FIG. 7, the first shell body 241 of the first shell 240 has at least one first through hole 241a, and the connector 121 of the electronic component 120 may be exposed from the first through hole 241a. The connector of the external electronic device may be connected to the connector 121 through the first through hole 241a.

Although not shown, the first shell 240 may further have at least one isolation portion similar to the aforementioned isolation portion 140r. The isolation portion is recessed relative to the surface 241s to form an interval between the second shell 250 and the first shell 240. This interval may increase the thermal resistance between the first shell 240 and the second shell 250 to prevent the temperature of the second shell 250 from being too high. In an embodiment, the isolation portion may be located corresponding a high temperature point of the second shell 250 (for example, a place with a higher temperature or the highest temperature) to reduce the temperature of such high temperature point.

As shown in FIGS. 8A and 8B, the first shell 240 has an end surface 240e, and the end surface 240e and the connection module 210 are spaced apart from each other. In the present embodiment, the first portion 2411 of the first shell body 241 of the first shell 240 has the aforementioned end surface 240e, wherein the gap g2 is spaced between the end surface 240e and the cover 212 of the connection module 210. The gap g2 may increase the thermal resistance between the first shell 240 and the connection module 210 to prevent the temperature of the second shell 250 from being too high. In addition, the gap g2 may absorb an assembly tolerance and avoid an interference between the first shell 240 and the connection module 210 due to the assembly tolerance.

As shown in FIG. 7, the first shell body 241 of the first shell 240 has a notch 241r, and the notch 241r is recessed relative to the end surface 240e of the first shell 240. When the first shell 240 is assembled with the connection module 210, the notch 241r may accommodate the connector 111 of the connection module 210 to prevent the physical material of the first shell body 241 from interfering with the connector 111.

As shown in FIGS. 7 and 8A, the second shell 250 has an accommodating groove 250p, an end surface 250e and a groove 250r, wherein the groove 250r extends from the end surface 250e toward a bottom portion of the accommodating groove 250p to form a groove bottom surface 250b. In addition, the second shell 250 is connected to the cover 212. For example, the second shell 250 and the cover 212 may be fixed to each other by using, for example, an ultrasonic welding process. The cover 212 has a bottom surface 212b, and the bottom surface 212b of the cover 212 is in contact with the groove bottom surface 250b of the second shell 250 by using, for example, an ultrasonic welding process. Through the ultrasonic welding process, the contact portions of the cover 212 and the second shell 250 are melted and fixed to each other.

As shown in FIGS. 7 and 8C, the second shell 250 includes a second shell 251 and at least one second coupling portion 252, wherein the second coupling portion 252 is disposed on the second shell 251. The second shell body 251 has the aforementioned first surface 200S1, the second surface 200S2, the third surface 200S3 and the fourth surface 200S4. In addition, the second shell body 251 has a surface 251s, and the second coupling portion 252 is recessed relative to the surface 251s. The surface 251s is, for example, an inner wall surface of the accommodating groove 250p. In an embodiment, the second shell body 251 and the second coupling portion 252 may form an integrally formed structure.

As shown in FIGS. 8C and 8D, the second coupling portion 252 of the second shell 250 and the first coupling portion 242 of the first shell body 241 may be combined with each other to fix a relative position between the first shell 240 and the second shell 250. The second coupling portion 252 of the second shell 250 and the first coupling portion 242 of the first shell body 241 match in shape, so that the first coupling portion 242 and the second coupling portion 252 are easily combined with each other. The first coupling portion 242 and the second coupling portion 252 may provide positioning and guiding functions. As a result, during the manufacturing process of the electronic device 200, through an alignment of the second coupling portion 252 and the first coupling portion 242, the first shell 240 and the second shell 250 may be quickly coupled. In an embodiment, a fit between the second coupling portion 252 and the first coupling portion 242 is, for example, a loose fit or a transition fit. Compared with an interference fit, the loose fit or the transition fit may effortlessly combine the first shell 240 and the second shell 250.

As shown in FIG. 7, the second shell 251 of the second shell 250 has at least one second through hole 251a, and the connector 121 of the electronic component 120 may be exposed from the second through hole 251a, so that the connector of the external electronic device may be connected to the connector 121 through the second through hole 251a.

As shown in FIGS. 8B and 8C, in the present embodiment, the second shell body 251 of the second shell 250 and the first shell body 241 of the first shell 240 may be at least partially spaced, for example, completely spaced. For example, the first shell body 241 includes a first portion 2411 (for example, an upper portion) and a second portion 2412 (for example, a lower portion) connected to the first portion 2411, and the second shell body 251 includes a third portion 2511 (for example, an upper portion) and a fourth portion 2512 (for example, a lower portion) connected to the third portion 2511. In the present embodiment, the first portion 2411 of the first shell 240 and the third portion 2511 of the second shell 250 are spaced apart from each other, and accordingly it may increase the thermal resistance between the first shell 240 and the second shell 250 and prevent the temperature of the second shell 250 from being too high. In addition, the second portion 2412 of the first shell 240 and the fourth portion 2512 of the second shell 250 are spaced apart from each other, and accordingly it may increase the thermal resistance between the first shell 240 and the second shell 250 and prevent the temperature of the second shell 250 from being too high. In addition, the first shell body 241 further includes a first bottom portion 2413 which connects the first portion 2411 and the second portion 2412, and the second shell body 251 further includes a second bottom portion 2513 which connects the third portion 2511 and the fourth portion 2512. The first bottom portion 2413 and the second bottom portion 2513 are spaced apart from each other, and accordingly it may increase the thermal resistance between the first shell 240 and the second shell 250 and prevent the temperature of the second shell 250 from being too high.

In another embodiment, the third portion 2511 of the second shell body 251 of the second shell 250 and the first portion 2411 of the first shell body 241 of the first shell 240 may be in contact with each other, the fourth portion 2512 of the second shell 251 and the second portion 2412 of the first shell body 241 of the first shell 240 may be in contact with each other and/or the second bottom portion 2513 of the second shell 251 of the second shell 250 and the first bottom portion 2413 of the first shell 241 of the first shell 240 may be in contact with each other.

In summary, the first shell body 241 of the first shell 240 and the second shell body 251 of the second shell 250 may be at least partially in contact with each other and/or at least partially spaced apart from each other. In addition, the first shell 240 and/or the second shell 250 are formed of an electrically insulating material, such as plastic, rubber, etc. However, in another embodiment, the first shell 240 and/or the second shell 250 are formed of a conductive material, for example. In addition, the first shell 240 and the second shell 250 may be formed of the same or different materials.

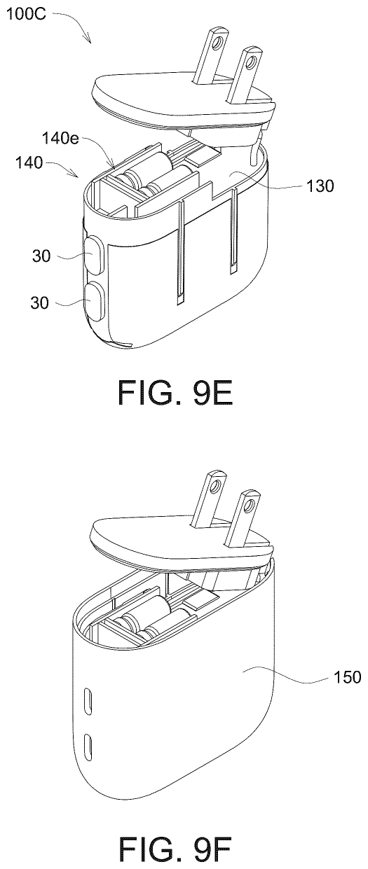

Referring to FIGS. 9A to 9F, FIGS. 9A to 9F illustrate schematic diagrams of the manufacturing processes of the electronic device 100 in FIG. 1.

As shown in FIG. 9A, the electronic component 120 and the connection module 110 are electrically connected, wherein the electronic component 120 and the connection module 110 form a first pre-assembled component 100A. In the present embodiment, the connection module 110 connects the electronic component 120 by the first connection line 111C and second connection line 111D.

As shown in FIG. 9B, the first shell 140 may be formed by using, for example, injection molding technology. Then, the heat conductive layer 160 is formed to cover at least a portion of the surface 141s1 of the first shell body 141 of the first shell 140 by using, for example, a lamination technology.

As shown in FIG. 9C, the first pre-assembled component 100A of FIG. 9A is formed within the first shell 140 of FIG. 9B, wherein the first pre-assembled component 100A and the first shell 140 form a second pre-assembled component 100B.

As shown in FIG. 9D, at least one plug 30 is disposed (or blocked) in at least one opening of the connector 121 (the connector 121 is shown in FIG. 9C) of the electronic component 120 to avoid the subsequently formed packaging materials 130 (the packaging material 130 is shown in FIG. 9E) to enters the inside of the connector 121. In an embodiment, the plug 30 is formed o, for example, rubber or plastic. However, as long as it may cover the opening of the connector 121 to avoid overflow of the packaging material in subsequent steps, the embodiment of the present invention does not limit the material, shape and/or size of the plug 30.

As shown in FIG. 9E, the packaging material 130 may be formed in the first shell 140 in FIG. 9D by using, for example, injection, potting or coating techniques. In FIG. 9E, the packaging material 130 covers at least a portion of the electronic component 120. In an embodiment, the top surface of the packaging material 130 does not exceed the end surface 140e of the first shell 140. In an embodiment, there is a gap between the top surface of the packaging material 130 and the end surface 140e of the first shell 140. Since the plug 30 is disposed in the opening of the connector 121 of the electronic component 120, the packaging material 130 may be prevented from entering the inside of the connector 121 through the opening of the connector 121.

Then, the plug 30 may be removed from the connector 121.

As shown in FIG. 9F, the assembly of FIG. 9D (with the plug 30 being removed) is disposed in the second shell 150, wherein the first shell 140 is located between the electronic component 120 and the second shell 150.

Then, the connection module 110 and the second shell 150 are combined to form the electronic device 100 as shown in FIG. 1 by using, for example, the ultrasonic technology.

The manufacturing method of the electronic device 200 includes the steps of the manufacturing method the same as or similar to that of the electronic device 100, and it may which will not be described again here.

In summary, embodiments of the present invention provide an electronic module, an electronic device using the same, and a manufacturing method. The electronic module includes a shell component and an electronic component, and the electronic component is disposed in the shell component. In an embodiment, the shell component is a multi-layer shell, which may include at least one inner shell and an outer shell (for example, the outermost layer of the shell). In another embodiment, at least one inner shell of the shell component may increase the thermal resistance of the heat conduction of the electronic component to the outer shell to prevent the temperature of the outer shell from being too high. In another embodiment, two of the plurality of shells of the shell component may be at least partially in contact with each other and/or at least partially spaced apart from each other. The spacer layer between two shells of the shell component is, for example, an air layer, which may form the thermal resistance to prevent the temperature (the temperature or average temperature at a certain point) of the shell of the shell from being too high. In other embodiments, the inner shell of the shell has an isolation portion. The isolation portion may increase the distance between the inner shell and the outer shell, and it may increase the thermal resistance of the heat conduction of the electronic component and the outer shell of the shell component to prevent the temperature (the temperature or average temperature at a certain point) of the shell of the shell from being too high.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. An electronic device, comprising:
an electronic component;
a first shell; and
a second shell;
wherein the first shell is located between the electronic component and the second shell, and the first shell and the electronic component are located within the second shell.

2. The electronic device according to claim 1, wherein the first shell and the second shell are at least partially spaced apart.

3. The electronic device according to claim 1, wherein the first shell and the second shell are at least partially in contact.

4. The electronic device according to claim 1, wherein the first shell comprises a first coupling portion, and the first coupling portion is in contact with a portion of a surface of the second shell.

5. The electronic device according to claim 1, wherein the first shell comprises a first shell and a first coupling portion, the first coupling portion is not coplanar with a surface of the first shell, the second shell comprises a second shell and a second coupling portion, the second coupling portion is not coplanar with a surface of the second shell, and the first coupling portion and the second coupling portion are disposed correspondingly.

6. The electronic device according to claim 1, further comprising:
a heat conductive layer disposed between the first shell and the second shell.

7. The electronic device according to claim 1, wherein the first shell has an outer surface and an isolation portion, the isolation portion is recessed relative to the outer surface, an interval between the first shell and the second shell is corresponding to the isolation portion, a gap between the first shell and the second shell is corresponding to a region outside the isolation portion, and the interval is greater than the gap.

8. The electronic device according to claim 1, further comprising:
a packaging material disposed within the first shell and covering at least a portion of the electronic component;
wherein the packaging material is in contact with a portion of the inner surface of the first shell.

9. The electronic device according to claim 1, further comprising:
a connection module electrically connected to the electronic component and combined with the second shell;
wherein the first shell has a first opening toward the connection module, the second shell has a second opening, and the connection module is disposed in the second opening.

10. The electronic device according to claim 9, wherein the first shell has an end surface, and there is a gap between the end surface and the connection module.

11. A manufacturing method for an electronic device, comprising:
electrically connecting the electronic component and a connection module, wherein the electronic component and the connection module form a first pre-assembled component;
disposing the first pre-assembled component within a first shell, wherein the first pre-assembled component and the first shell form a second pre-assembled component;
disposing the second pre-assembled component within a second shell, wherein the first shell is located between the electronic component and the second shell; and
combining the connection module with the second shell.

12. The manufacturing method according to claim 11, further comprising:
forming a packaging material within the first shell, wherein the packaging material covers at least a portion of the electronic component.

13. The manufacturing method according to claim 12, wherein the electronic component comprises a connector exposed from the first shell; before forming the packaging material within the first shell, the manufacturing method further comprises:
disposing a plug in an opening of the connector.

14. The manufacturing method according to claim 11, wherein combining the connection module with the second shell comprises:
combining the connection module with the second shell by an ultrasonic technology.

15. An electronic device, comprising:
an electronic assembly;
a first shell;
a second shell, wherein the first shell and the electronic assembly are disposed within the second shell;
an packaging material disposed within the first shell and covering at least a portion of the electronic assembly; and
a connection module connected to the second shell, wherein the first shell has an end surface facing the connection module.

16. The electronic device according to claim 15, wherein the connection module abuts against the second shell at an abutment portion, and there is a gap between the end surface and the abutment portion.

17. The electronic device according to claim 15, wherein the packaging material contacts a portion of an inner surface of the first shell, and a top surface of the packaging material does not exceed the end surface of the first shell.

18. The electronic device according to claim 15, wherein a portion of the outer surface of the first shell has a heat conductive material.

19. The electronic device according to claim 15, wherein the first shell has a through hole, and the through hole and the end surface are disposed on different sides of the first shell.

20. The electronic device according to claim 15, wherein the first shell comprises a first portion, a second portion and a first opening facing the connection module, and at least a portion of the first portion is not connected to the second portion.
